(19) United States
(12) Patent Application Publication
(10) Pub. No.: US 2011/0200787 A1
(43) Pub. Date: Aug. 18, 2011

(54) Suspended Thin Film Structures

(75) Inventors: William R. Regan, Berkeley, CA (US); Alexander Zettl, Kensington, CA (US); Benjamin J. Aleman, Berkeley, CA (US)

(73) Assignee: THE REGENTS OF THE UNIVERSITY OF CALIFORNIA, Oakland, CA (US)

(21) Appl. No.: 13/013,645

(22) Filed: Jan. 25, 2011

Related U.S. Application Data
(60) Provisional application No. 61/298,326, filed on Jan. 26, 2010.

(51) Int. Cl. B32B 9/00; B32B 37/02; B32B 37/14; B32B 38/10; C23F 1/00; B32B 3/10; B82Y 30/00

(52) U.S. Cl. 428/138; 156/230; 216/36; 216/37; 977/734

(57) ABSTRACT

Disclosed is a method of preparing a support structure suitable for use, e.g., in microscopic studies, comprising a free standing atomically thin film (e.g. graphene) suspended across an opening in the support structure. The method in one aspect comprises the steps of preparing a thin film which is an atomically thin film (e.g., graphene) on a surface of a solid substrate to form a graphene-layered substrate; attaching the graphene layer to a hole-containing support mesh; removing the solid support, thereby transferring the graphene layer from the substrate to the carbonaceous hole-containing layer on the support mesh; and then removing contaminants to obtain said structure. In another aspect, the present method does not involve a transfer, but comprises a lithography and etching process in which the atomically thin layer is applied to a support which is marked with a lithographic pattern and selectively etched, leaving the free standing film.

### CROSS-REFERENCE TO RELATED APPLICATIONS

This application claims priority from U.S. Provisional Patent Application No. 61/298,326, filed on Jan. 26, 2010, which is hereby incorporated by reference in its entirety.

REFERENCE TO SEQUENCE LISTING, COMPUTER PROGRAM, OR COMPACT DISK

None.

### STATEMENT OF GOVERNMENTAL SUPPORT

This invention was made with U.S. Government support under U.S. Department of Energy Contract Number DE-AC02-05CH11231. The Government has certain rights in this invention.

### BACKGROUND OF THE INVENTION

1. Field of the Invention

The present invention relates to the field of devices that comprise an atomically thin film or sheet (e.g., graphene) suspended across a hole or mesh openings, including such devices as made and adapted for use in supporting samples for transmission electron microscopy.

2. Related Art

Presented below is background information on certain aspects of the present invention as they may relate to technical features referred to in the detailed description, but not necessarily described in detail. That is, individual parts or methods used in the present invention may be described in greater detail in the materials discussed below, which materials may provide further guidance to those skilled in the art for making or using certain aspects of the present invention as claimed. The discussion below should not be construed as an admission as to the relevance of the information to any claims herein or the prior art effect of the material described.

Graphene, a single atomic monolayer of sp²-bonded hexagonal carbon with extraordinary mechanical, electronic, and optical properties, has become an area of intense research since its experimental isolation by the mechanical cleavage of graphite. In the years since this breakthrough, more synthesis methods have emerged to isolate single to few layer graphene, such as epitaxial growth on SiC, oxidative/thermal intercalation and ultrasonication of graphite, and, most recently, by chemical vapor deposition on metal substrates such as Ni and Cu. In particular, Cu growth has garnered considerable interest due to its ability to produce macroscopic areas of mostly monolayer graphene, with domain sizes comparable to the size of the largest flakes that can be produced by mechanical exfoliation. The availability of these several varied graphene syntheses gives researchers a flexibility that is helping to accelerate basic research and application of this novel material. An exemplary method of preparing a graphene film is given in Li et al., “Large-Area Synthesis of High-Quality and Uniform Graphene Films on Copper Foils,” Science, 5 Jun. 2009: Vol. 324. no. 5932, pp. 1312-1314. The authors grew large-area graphene films of the order of centimeters on copper substrates by chemical vapor deposition using methane. The films were predominantly single-layer graphene, with a small percentage (less than 5%) of the area having few layers (i.e., “essentially single layer”), and are continuous across copper surface steps and grain boundaries.

One significant application of graphene is derived from its unique physical structure, which makes it ideally suited for use as a transmission electron microscopy (TEM) support. Graphene is only a single carbon atom thick, an order of magnitude thinner than the best currently available amorphous TEM supports. This thinness and the low atomic number of carbon make graphene almost completely transparent to the electron beam. The slight beam interaction with the hexagonal carbon monolayer generates a well-defined signal that can easily be subtracted from resulting images and diffraction patterns. Somewhat counterintuitively, one can achieve higher resolution images of a graphene-supported object than of a similar suspended object because, despite not being perfectly transparent to the electron beam, the graphene support helps dampen beam-induced vibrations that would blur the suspended object. Graphene may therefore be the best possible TEM support for studying a variety of materials, namely nanostructures and biological molecules that could otherwise not be resolved with conventional TEM supports. Graphene flakes produced via mechanical exfoliation, with diameters up to tens of microns, have been previously transferred from SiO₂ to holey carbon TEM grids, as described in Meyer et al., Appl. Phys. Lett. 92:123110 (2008). Alternatively, TEM grids have been constructed on top of exfoliated flakes. In one clever approach, a TEM grid has been electrochemically grown on top of an exfoliated graphene flake, producing graphene TEM supports with sizes limited only by exfoliated flake sizes. This is described in Booth et al., Nano Lett. 8:2442 (2008). These methods, however, require either delicate or cumbersome processing. Both rely on the nontrivial art of exfoliating large graphene flakes. And both methods limit the suspended graphene area to exfoliated flake sizes, 100 microns in diameter at most. Such a small target window makes sample preparation difficult and unreliable.

Layer-area graphene growth as described below is a means to prepare truly macroscopic graphene TEM supports. The nature of layer-area synthesis, however, required a new method of TEM grid preparation. So far, transfer of layer-area graphene from metallic growth substrates to more useful substrates (insulators, TEM grids) has been achieved using a polymer coating as a temporary rigid support during etching of the metal to prevent destruction of the graphene via folding or tearing. Some examples of these polymers are poly[methyl methacrylate] (PMMA), polydimethylsiloxane (PDMS), and polycarbonate (PC). However, these methods require several wet chemical steps that introduce contamination and mechanical damage, resulting in large but dirty and often cracked graphene sheets. For example, in addition to the unavoidable Cu etchant exposure, PMMA transfer exposes the graphene to PMMA, acetone, and forces which may bend and shear the thin PMMA graphene membrane during transfer from the etchant to post-etch deionized water baths and again from the water baths to the target substrate. Further, such methods do not necessarily result in a strong bond between the graphene and the target substrate, and poor adhesion may result in unstable graphene TEM supports.

### SPECIFIC PATENTS AND PUBLICATIONS

US 2006/0277778 by Mick et al., published Dec. 14, 2006, entitled “Reusable template for creation of thin films; method of making and using template; and thin films produced from template,” discloses templates used in the creation of thin-film replicas, for example, the creation of thin films, such as carbon films, for use as specimen support in electron-beam specimen analysis.

Meyer et al., “Hydrocarbon lithography on graphene membranes,” Appl. Phys. Lett. 92:123110-1-123110-3 (28 Mar. 2008) and Meyer et al., “Imaging and dynamics of light atoms and molecules and graphene,” Nature, 454:319-322 (17 Jul. 2008) describe TEM images where a graphene membrane was used as a support. That method, however, employed graphene prepared by mechanical cleavage with an adhesive tape and transfer of the selected sheets to commercially available TEM grids.

### BRIEF SUMMARY OF THE INVENTION

The following brief summary is not intended to include all features and aspects of the present invention, nor does it imply that the invention must include all features and aspects discussed in this summary.

In certain aspects, the present invention comprises a method of preparing a structure that has a thin film, only about one atom thick, which has a macroscopic two dimensional size and is suspended across an aperture. This structure is suitable for use in microscopic scale studies, such as in a transmission electron microscope, where the object being studied needs to be in an environment free of nanoscale defects. A method is provided for preparing a structure comprising an atomically thin film suspended across at least one hole in a support mesh, comprising the steps of: (a) obtaining an atomically thin film layer on a surface of a solid substrate prepared by depositing a material that forms an atomically thin film (ATF) layer on the surface of the substrate to form an atomically thin film-layered substrate; (b) attaching the atomically thin film layer on the ATF layered substrate from step (a) to a support mesh; (c) removing the solid support, leaving the ATF layer from the substrate attached to the support mesh; and then (d) removing contaminants to obtain said structure suitable for microscopic scale studies having an ATF layer suspended across at least one hole in a support mesh. The support mesh, which contacts the ATF layer, may itself be supported on an underlying grid, exemplified by holey carbon on a TEM grid, which is commercially available in grid materials of Ni, Au and Rh plated Cu. Removing the solid support is carried out without removing the grid.

In certain aspects, the present invention comprises a method of preparing a structure suitable for microscopic scale studies, where the ATF layer is represented and described here by the non-limiting example of graphene. It should be understood that aspects of the present invention described as involving graphene being bonded to a carbonaceous material may also be applied to other ATF layers bonded to other compatible support meshes.

In certain aspects, the present invention comprises comprising the steps of: preparing a graphene layer on a surface of a solid substrate by depositing a carbon atom containing material that forms a graphene layer on the surface of the substrate to form a graphene-layered substrate; attaching the graphene layer on the graphene layered substrate from step (a) to a carbonaceous hole-containing layer on a support mesh; removing the solid support, leaving the graphene layer from the substrate attached to the carbonaceous hole-containing layer on the support mesh; and then removing contaminants to obtain said structure suitable for microscopic scale studies having a graphene layer suspended across at least one hole in a support mesh.

The ATF that is used should be essentially single layer. This is exemplified by planar sp² bonded materials such as graphene. Also, the graphene layer is preferably pristine, meaning that is has predominantly intact sp² bonds in an essentially planar orientation. The solid substrate is etchable with a material that does not etch the ATF (e.g., carbon). This substrate may be a metal. In certain aspects, the present invention comprises a solid substrate which is a metallic material which contains copper, nickel, silver, ruthenium, palladium, platinum, or other metals with low carbon solubility. These may be elemental. In some embodiments the solid substrate contains silicon.

In certain aspects, the present invention comprises a carbonaceous carbon layer which is holey carbon. Holey carbon is an art-recognized term, as elaborated on below. In the most general sense, it is a layer of carbon with holes in it. Holey carbon is used in electron microscopy, where it is placed over a metal mesh so that the holes in the carbon are over holes in the grid and are not blocked. The holey carbon may be amorphous carbon (a-C). The size and number of holes in the carbonaceous layer may be varied. The holey carbon may have a nominal sieve opening of between 100 nm and 100 μm, or, for example, between 2-9 μm. That is, the holes are of this nominal diameter, although they need not be circular.

In certain aspects, the present invention comprises a process where etching removes the support mesh up to, but not including, the attached ATF, to produce the suspended ATF.

In certain aspects, the present invention comprises a step of attaching the graphene layer (ATF) to the carbonaceous hole-containing layer (support mesh) by adding a solvent to a junction between said graphene layer and carbonaceous hole-containing layer. The exemplified solvent is isopropyl alcohol. The solvent material may be another lower alkyl alcohol (C₁₂ or less). The solvent material may be the only material used to accomplish bonding between the ATF and the support mesh;

In certain aspects, the present invention comprises structure for use in preparing a microscopic support structure comprising elements as referred to above: an essentially single layer graphene layer on a substrate; and a carbonaceous hole-containing layer on a support mesh attached to said graphene layer by bonding of the graphene layer to the carbonaceous hole-containing layer.

In certain aspects, the present invention comprises a structure where the support mesh comprises a gold grid. Gold is known for use in TEM grids. Other metals known for use in TEM grids may be used. The carbonaceous hole-containing layer may be holey amorphous carbon placed on a grid. The holey amorphous carbon may have a nominal sieve opening size of between 100 nm and 100 μm, or, e.g., between 1 and 10 μm.

The present invention comprises, in certain aspects, a method for forming a graphene sheet that spans an aperture, or an array of apertures on a solid support mesh. The graphene sheet then is free standing across the holes that it spans. In certain embodiments, the hole need not be entirely through the solid support mesh, only deep enough to leave a free standing portion of graphene or ATF material.

The method generally is exemplified by a process in which, first, layer-area graphene is grown on a copper foil/film via chemical vapor deposition, as reported, for example in Li et al. Science, 324, 1312 (2009).

The present method comprises one step (a), comprising the preparation of a relatively large area of graphene grown on a copper film.

In another step (b), a grid material inert to copper etchants (e.g., gold) with a holey carbon supported film thereon is placed on top of the graphene-copper structure from step (a), with the holey carbon film layer in contact with the graphene layer.

Next, in a step (c), a solvent such as isopropanol (IPA) is applied to the structure so that it wets the amorphous carbon and the graphene layers; it is evaporated to bond these two layers. The sample is also baked (e.g. 10-20 min. on a hot plate at 120° C.) to strengthen the bond.

Then, in step (d), the copper is partially or wholly removed from the graphene/holey carbon composite. In one method, the sample is “floated” with the copper film downwards on a solution of a copper etchant, such as aqueous FeCl₃, to remove the underlying copper foil. After removal of the foil and any organics, the structure is dried and ready for use.

The method as described above is advantageous in certain respects in that it may be used with pre-formed or commercially available supports, such as QUANTIFOIL®—Holey Carbon Film supports. The graphene (or other ATF) layer is transferred to the holey carbon (or other support mesh, which may have an array of holes). In an alternative embodiment, described below, the ATF layer is not transferred; in contrast, the suspended film is formed in place.

Thus, according to this embodiment, the present invention comprises a method of preparing a structure suitable for use in microscopic scale studies, the structure comprising an atomically thin film (ATF) suspended across holes in a support mesh, comprising the steps of: (a) obtaining an ATF layer on a surface of a solid substrate prepared by depositing a material that forms an ATF layer on the surface of the substrate, where the substrate has an ATF layered side and an opposing second side of the substrate; (b) preparing an etching pattern on the second side of the substrate where the pattern is defining portions of the substrate to be etched; then (c) etching the defined portions to remove substrate, leaving the ATF layer suspended across holes formed by etched portions; and then (d) removing contaminants to obtain said structure suitable for microscopic scale studies having an ATF layer suspended across holes in a support mesh.

Using again graphene as a non-limiting ATF example, the method may further be described as involving a process where an upper graphene layer is removed and the Cu foil is coated with positive photoresist. A photomask defining the structure of the final product, that is a complete TEM grid, is placed over the structure, exposed to light and exposed to photoresist developer and copper etchant, etching through the exposed copper until it reaches the lower graphene layer, resulting in suspended graphene regions. Removal of the upper graphene layer is carried out if, during chemical vapor deposition (CVD) growth, the deposited graphene coats all surfaces of the substrate (e.g., Cu foil).

### BRIEF DESCRIPTION OF THE DRAWINGS

FIG. 1A is a schematic drawing showing the transfer process for preparing a transmission electron microscopy (TEM) grid with a graphene layer; FIG. 1B shows the transfer-free method.

FIG. 2 is a schematic diagram showing the transfer method of FIG. 1A in further detail (right side) and comparing it to a prior art method (left side).

FIG. 3 is a series of micrographs showing graphene grids made according to the present transfer process. FIG. 3A Optical microscopy showing nearly complete adhesion (top edge not yet adhered) between the TEM grid's a-C film and the graphene on Cu, shown during the evaporative sticking process. Scale=0.5 mm. FIG. 3B TEM image of a portion of a grid frame showing large-domain, clean graphene sheets with some cracks and folds. Scale=10 um. FIG. 3C TEM image of clean, single grain graphene covering a-C hole. Scale=0.5 um.

FIG. 4 shows a TEM image of a low defect region of the present graphene films made by the transfer process. FIG. 4A is a typical image of a low-defect region with large atomically clean areas. Scale=25 nm. FIG. 4B is selected area diffraction (SAD) image of this region showing the hexagonal structure of the (0001) basal plane. Tilt measurements performed in this region yielded invariant diffraction intensities, a strong indicator of monolayer graphene.

FIG. 5A shows TEM image of a region with a fold or grain boundary in the graphene. Scale=50 nm. FIG. 5B Selected area diffraction (SAD) image of this region showing the hexagonal graphene structure, with small and large angle separation of diffraction spots due to sheet misalignments resulting from the fold or grain boundary.

FIG. 6A-E shows the transfer-free embodiment of the present method, where graphene TEM grids are prepared by etching the copper substrate in a pattern defined by photolithography.

FIG. 7 is an optical micrograph of a graphene TEM grid (with Cu support) fabricated by the process of Example 3. The grid is shown from the top (graphene side). The etching was performed on the back side (facing away from the viewer). The dark/grey regions are areas where the Cu has been etched away, leaving suspended graphene regions. [The small tab of Cu on the top of the circular TEM grid is left unetched so that many graphene TEM grids can be easily batch processed on the same sheet of Cu. If there were not a tab, all the grids on a particular Cu sheet would detach during the etching process, making subsequent cleaning and drying difficult.]

FIG. 8 is an optical micrograph of the graphene TEM grid shown in FIG. 7 at higher magnification, as shown by the scale bar. This zoomed-in image shows finer detail of the array of suspended graphene regions. The holes have an average diameter of approximately 60 μm. Again, the holes are regions where the Cu has been etched away to expose regions of suspended graphene. In some embodiments holes between 30-60 μm in diameter may be used, with 25 μm thick Cu foil for improved yields. Yields (i.e. regions of intact suspended graphene) have been found to be affected by the hole diameter used. Thinner foils also had reduced yields, under the conditions used.

FIG. 9 is a TEM image of one of the suspended graphene regions shown in FIG. 7 and FIG. 8. The graphene, itself nearly transparent to the beam, is made visible by small clusters of unetched Cu (small dots). A small crack in the graphene film is visible in the lower left portion of the circle, near the scale bar. The dark region surrounding the suspended graphene is the Cu support substrate.

### DETAILED DESCRIPTION OF THE PREFERRED EMBODIMENT

### Definitions

Unless defined otherwise, all technical and scientific terms used herein have the same meaning as commonly understood by those of ordinary skill in the art to which this invention belongs. Although any methods and materials similar or equivalent to those described herein can be used in the practice or testing of the present invention, the preferred methods and materials are described. Generally, nomenclatures utilized in connection with, and techniques of physics, materials science and chemistry are those well known and commonly used in the art. Certain experimental techniques, not specifically defined, are generally performed according to conventional methods well known in the art and as described in various general and more specific references that are cited and discussed throughout the present specification. For purposes of the clarity, following terms are defined below.

The term “atomically thin film” or “ATF” is used herein to refer to a continuous two-dimensional material that is nominally one atom thick and that is of an area larger than a flake, referred to in the art as “layer area.” The ideal film is essentially chemically pure and defect-free. In practice, regions of multiple atomic layers, bond breaks and impurities may be present. Preferred here are non-metal ATFs, exemplified by graphene, BN, BxCyNz, and thin film dichalcogenides.

BN refers to boron nitride. ATFs of boron nitride are described, e.g., in Pacile et al., “The two-dimensional phase of boron nitride: few-atomic-layer sheets and suspended membranes,” Appl. Phys. Lett., 92:133107-1-133107-3 (2008). This paper also describes the transfer of a BN flake to a carbon film using IPA. Alem et al., “Atomically thin hexagonal boron nitride probed by ultrahigh-resolution transmission electron microscopy,” Physical Review B, 80, 155425 (2009) describes a method to prepare monolayer and multilayer suspended sheets of hexagonal boron nitride h-BN, using a combination of mechanical exfoliation and reactive ion etching.

BxCyNz refers to boron-carbon-nitride materials as described in US PGPUB 20010023021 “BxCyNz nanotubes and nanoparticles,” published Sep. 20, 2001, and N. G. Chopra, R. J. Luyken, K. Cheney, V. H. Crespi, M. L. Cohen, S. G. Louie, and A. Zettl. “Boron nitride nanotubes,” Science, 269, 966 (1995). As described there, typically x, y, and z are integers including zero, where no more than one of x, y, and z are zero for a given stoichiometry. The x, y, and z subscripts indicate the relative proportion of each element with respect to the others. For example, y may be zero yielding the formula BxNz; z may be zero yielding the formula BxCy; or x may be zero yielding the formula CyNz. In the circumstances that the BxCyNz structures are doped with added elements or molecules, the subscripts x, y, and z will take on non-integer values. For example, the ratio of boron:carbon:nitrogen may be about 1:2:1, about 1:3:0, about 1:0:1, or about 0:1:1.

The term “dichalcogenides” refers to transition metal dichalcogenides, described by the formula M₆C_{y}H_{z}, 8.2<y+z<10, where M is a transition metal (Mo, W, Ta, Nb), C is a chalcogen (S, Se, Te); H is a halogen (I). Methods for preparing these films are disclosed in Faris, US 2007/0158789 A1 entitled “Material comprising predetermined number of atomic layers and method for manufacturing predetermined number of atomic layers,” published Jul. 12, 2007.

U.S. Pat. No. 5,279,720 entitled “Electrophoretic deposition of transition metal dichalcogenides,” issued Jan. 18, 1994, illustrates the deposition of molybdenum disulfide onto an aluminum substrate, onto stainless steel and a conductive polymer. The patent suggests that the methods used there produce single molecular layer particles. Other transition metal dichalcogenide coatings (i.e., MoSe₂, NbS₂, NbSe₂, TaS₂, TaSe₂, WSe₂, WS₂, and combinations with and without MoS₂) can be obtained by using appropriate transition metal dichalcogenides in place of or in addition to the molybdenum disulfide.

The term “layer area,” is used herein in its art recognized sense. It is sometimes referred to in the literature as “large area,” see, e.g., Levendorf et al., “Transfer-Free Batch Fabrication of Single Layer Graphene Transistors,” Nano Lett. 9:4479-4483 (Oct. 27, 2009). It refers to a film size that can cover a relatively large area while remaining in form an essentially single layer of atoms in thickness. Graphene films have been fabricated, for example, that consist of regions of 1 to 12 graphene layers. Single- or bilayer regions can be up to about 20 μm in lateral size. As described below, by way of example, “layer area” suspended graphene films between 100-3000 μm² may be prepared using the present methods.

The term “essentially single layer” is used herein to refer to an atomically thin film which is predominantly one atom thick. For example, single-layer graphene, with a small percentage (less than 5%) of the area having few layers and continuous across copper surface steps and grain boundaries have been prepared. In addition, essentially single layer means that the film is in the form of a sheet one atom thick, except that defects in certain areas (e.g., at least less than 30% of the surface or less than 50% of the surface) are to be found where several layers exist.

The term “holey carbon” is used herein to refer to a thin layer of essentially pure carbon that is discontinuous, that is, has holes through it. Such perforated carbon films are known in the art and are termed as being either “holey” or “lacey” carbon filmed grids. In some instances, these same films are referred to as “microgrids”. Holey carbon grids or holey carbon film is commercially available at Quantifoil Micro Tools GmbH, Jena, Germany or Pacific GridTech, San Diego, USA).

The term “carbonaceous” is used herein to refer to a material comprising at least 65% carbon. It may be elemental carbon, or a derivative, such as an oxide. It may be amorphous or crystalline carbon. The material may be specified as having, e.g., at least 90% carbon, at least 99% carbon, etc.

The term “low carbon solubility” is used in its standard sense. A low carbon solubility is considered to be a concentration of about 0.5 percent or less, by weight. Preferably, the carbon concentration is about 0.5 percent, more preferably 0.1 percent and most preferably 0.05 percent. For example, in the case of nickel, one may see a concentration of carbon in the range of between about 0.01 and 0.02 percent. For example, high solubility metals are Ce, La, La—Ni, Fe and Mn. Low solubility metals are copper, nickel, silver, ruthenium, palladium, platinum, and the like.

### Overview

The present invention comprises facile methods for the fabrication of atomically thin, freestanding films. In these methods, an ATF (atomically thin film), exemplified herein by graphene, is suspended across holes in a support mesh, exemplified here by holey amorphous carbon in a transfer method, or in etched support material in a non-transfer method. One method involves the direct transfer of layer-area graphene to holey amorphous carbon transmission electron microscopy (TEM) grids. Holey amorphous carbon is a known TEM substrate. Any holey carbon material, having holes on the order of μm can be used, preferably between about 1 and 7 μm. The pitch between holes can be varied, e.g., between about 1 and 20 μm and the holes can also be square, in the form of a rectangular mesh.

The present method comprises direct attachment of the holey carbon (support mesh) to the graphene (ATF). It avoids several wet chemical steps and the accompanying mechanical stresses and contamination common to all presently reported layer-area graphene transfer methods and results in remarkably robust, clean, full-coverage graphene TEM grids ideal for high resolution TEM and with exciting potential applications in novel electronic and optical experiments. The present support structures provide relatively large area atomically thin films suspended in a support mesh. These structures may be connected to devices utilizing important properties of, e.g. graphene, such as high thermal conductivity, high carrier mobilities, and an anomalous quantum Hall effect. The present process achieves macroscopic graphene transfer to TEM grids (specifically, those with a holey amorphous carbon (a-C) support film) with previously unattainable cleanliness and graphene/grid bond strength. While large area graphene transfer has previously been demonstrated using an intermediate polymer support, our process is simpler, cleaner, more reliable, and more readily portable to industrial-scale production. Although not described here in detail, the present transfer methods have also been demonstrated in Au gilder fine mesh grids, Quantifoil grids with a formvar polymer coating, and Au grids with lacey carbon.

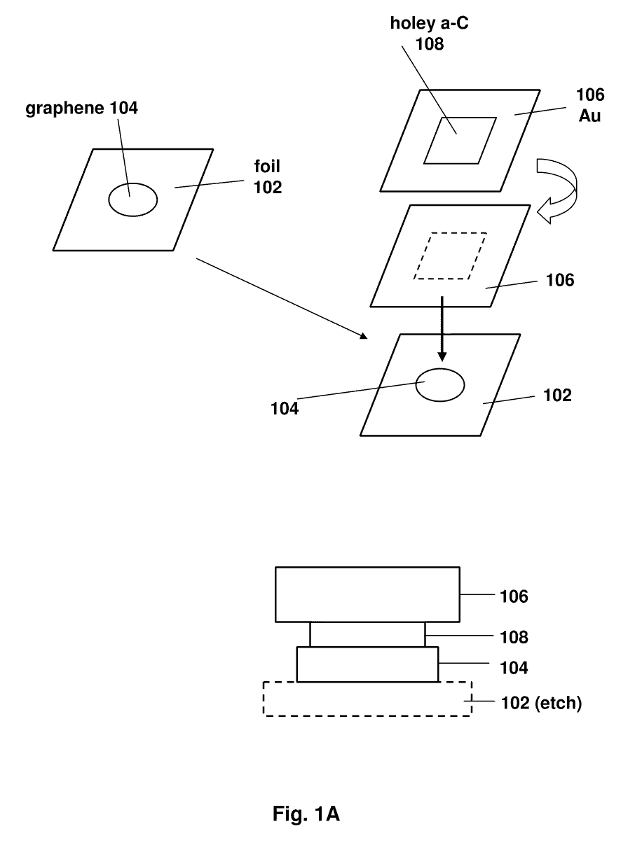

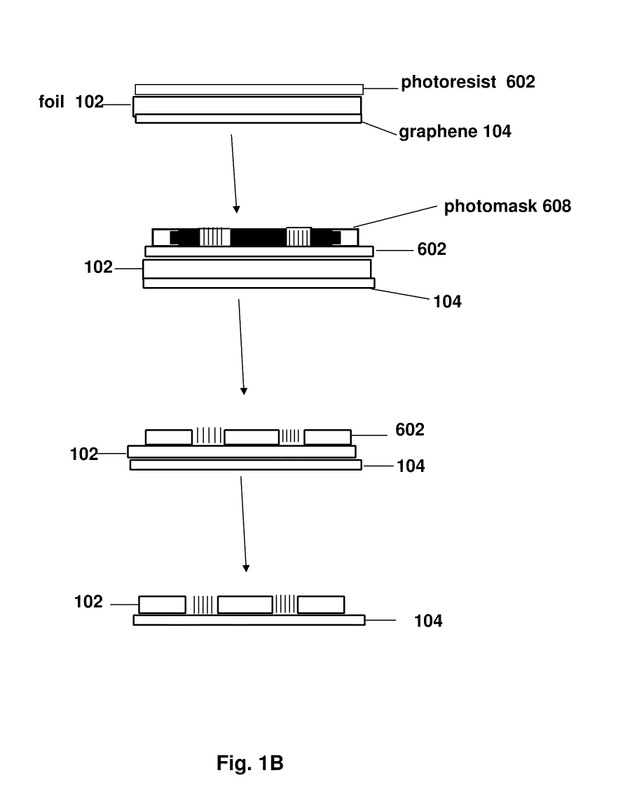

FIG. 1 shows a schematic illustration of the present method. Referring now to FIG. 1A, the method generally is exemplified by a process in which, first, layer-area graphene 104 is grown on a copper foil or film 102 via chemical vapor deposition, as reported, for example in Li et al. Science, 324, 1312 (2009). This step comprises the preparation of a relatively large area of graphene grown on a copper film.

The chemical vapor deposition may be accomplished by a variety of methods. Yuan et al., “Graphene sheets via microwave chemical vapor deposition,” Chemical Physics Letters, 47(4-5)361-364 (5 Jan. 2009) disclose that high-quality graphene sheets (GS) were synthesized on stainless steel substrates at about 500° C. by microwave plasma chemical vapor deposition (CVD) in an atmosphere of methane/hydrogen mixture. The GS product was characterized to contain mostly 1- or 2-3-layers using scanning electron microscopy, transmission electron microscopy/selective area electron diffraction, atomic force microscopy, and Raman spectroscopy. This represents a suitable CVD approach capable of producing graphenes with high yield and high purity with no carbon impurities such as carbon nanotubes. One may grow graphene on copper foils at temperatures up to 1000° C. by CVD of carbon using a mixture of methane and hydrogen.

Also, methods for chemical vapor deposition on a copper or other metal film to form a few-layer thick graphene sheet are disclosed in Li et al., “Large-Area Synthesis of High-Quality and Uniform Graphene Films on Copper Foils,” Science, 324:1312-1314 (May 7, 2009). As reported there, the authors grew large-area graphene films of the order of centimeters on copper substrates by chemical vapor deposition using methane. The films were predominantly single-layer graphene, with a small percentage (less than 5%) of the area having few layers, and are continuous across copper surface steps and grain boundaries. The growth of graphene on Cu foils of varying thickness (12.5, 25, and 50 μm) also yielded similar graphene structure with regions of double and triple flakes but neither discontinuous monolayer graphene for thinner Cu foils nor continuous multilayer graphene for thicker Cu foils. This process can be used to grow graphene on 300 mm copper films on Si substrate. In one preferred embodiment, the Cu foil is between 10 and 25 μm thick

Alternatively, there are other known methods of producing films with atomic precision. These include, deposition by sputtering, electron beam, ion beam, molecular beam epitaxy, MOCVD, plasma, laser deposition, pyrolitic deposition, electrochemical, thermal evaporation, sputtering, electro-deposition, molecular beam epitaxy, adsorption from solution, Langmuir-Blodgett (LB) technique, self-assembly and many other related methods collectively referred to as Thin Film Deposition Methods. Accurate metrology enables the production and control of thicknesses with Angstrom precision.

In another step of the present method, a material inert to copper etchants (e.g., gold) TEM grid 106 with an amorphous carbon supported film 108 is placed on top of the graphene-copper structure 102 and 104, with the amorphous carbon film layer 108 in contact with the graphene layer 104. The support or TEM grid 106 may be a gold (or other material inert to copper etchants) Quantifoil TEM grid with a holey a-C (hole diameters on the micron scale) support film 108, which, as stated, is placed on top of the graphene on copper, such that the a-C film faces down towards the graphene. A wide variety of TEM grids are commercially available and can be adapted for use in the present invention. Grids contain Cu, Ni, Au, Mo and Cu/Pd and are formed in meshworks. These meshworks may be fitted with a holey carbon film over 200 or 300 mesh. Thus, the support structure will have a metal layer and a carbon layer. A variety of etchants can be used; they will be selected to etch the substrate but not the ATF. For a copper-graphene structure, other etchants such as cupric chloride, sodium persulfate, ammonium persulfate, hydrochloric acid, etc. may be used. Such etchants may also be used to remove contaminants from the structure that may remain on the graphene layer.

A drop of isopropanol (IPA) (or other grid-compatible solvent with appropriate surface tension) is gently placed on top of the grid structure and wets both the grid's a-C film and the underlying graphene film. A variety of alcohols may be used, including primary, secondary or tertiary, cyclic, C₁ to C₁₂ straight or branched chain or cyclic alcohols. They may be selected from C₁ to C₆, C₁ to C₃, C₂ to C₁₂, C₆ to C₁₂ or C₂ to C₆. It may be for example methanol, ethanol, 1- or 2-propanol, 1-butanol, 2-butanol, isobutanol, tert-i5 butanol, cyclopentanol, cyclohexanol or some other alcohol. In some cases a mixture of two or more alcohols selected from those described above may be used. Also, a combination of solvents may be used.

Other materials having suitable surface tension are as follows:

| Hexane | 17.91 (25° C.) |
|---|---|
| Iso-Octane | 18.77 |
| Acetonitrile | 19.10 |
| Methyl t-Butyl Ether | 19.4 (24° C.) |
| Heptane | 20.30 |
| Triethylamine | 20.66 |
| Isopropyl Alcohol | 21.79 (15° C.) |
| Ethyl Alcohol | 22.32 |
| Cyclopentane | 22.42 |
| Methanol | 22.55 |
| Isobutyl Alcohol | 22.98 |
| Acetone | 23.32 |

The fluid used here, termed generally a solvent, is used to draw together the two layers being bonded. Without wishing to be bound by any scientific theory, the use of the solvent here may be further illustrated by principles of stiction (static friction). This is akin to capillary adhesion. See, Tas et al., “Stiction in surface micromachining,” J. Micromech. Microeng. 6 (1996) 385-397 for further details on selection of appropriate solvents for the present methods. The solvent is thought to cause binding because, as the solvent evaporates, surface tension draws the graphene and a-C together into intimate contact. This method has been previously applied to draw exfoliated graphene flakes onto TEM grids. The completeness of the sticking between the graphene and a-C can be confirmed by optical microscopy, as optical interference effects give a noticeable contrast between stuck and unstuck regions. If certain regions remain unstuck, more IPA may be dropped on the sample and evaporated until all regions of the films are adequately bonded.

In one preferred method, the sample may then be baked on a hot plate to remove the solvent from the ATF-substrate interface. For example, it is baked at 120 degrees Celsius for 10 to 20 minutes to evaporate any remaining IPA and strengthen the graphene/a-C bond.

In another step in the present process, the CVD substrate 102 onto which the graphene layer 104 was deposited is removed (102 [etch] in FIG. 1A). For example, the sample is floated—again oriented such that the TEM grid 106 rests on top of the copper film—on a solution of aqueous FeCl₃ (or other copper etchant) in order to remove the underlying copper foil. After etching, the sample—now referred to as a graphene TEM grid—is floated on deionized water to wash off remaining copper etchant. After a brief bath in IPA to encourage effective drying and remove organics, the grid is ready for use.

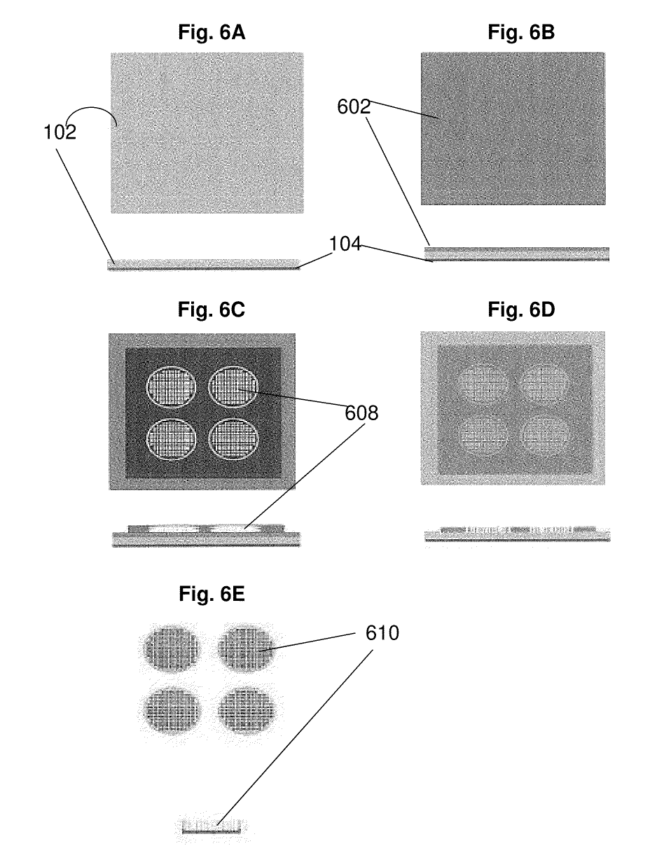

As shown in FIG. 1B, and FIG. 6, an alternative embodiment involves removing the copper foil layer 102 after it is coated with a photoresist so that it may be selectively removed according to a desired pattern. In this case, the substrate itself is etched to form holes in a support mesh across which the ATF is suspended. Again, graphene is used as an example. Graphene 104 is applied to an etchable support 102 (e.g., copper) by chemical vapor deposition to form a continuous layer area graphitic ATF. As discussed in more detail in the next paragraph, the graphene will coat both layers of the substrate due to the nature of the CVD process and equipment used. (Only one layer is illustrated.) One therefore removes the graphene from one side of the substrate and exposes the copper, which is to be etched. It is then coated with a positive photoresist. A photomask containing the structure of the entire TEM grid (scaffolding, outer support ring, etc.) is placed over the substrate and given the appropriate dose of UV light (the photomasks can be designed to have any arbitrary geometric layout; for instance, a mask containing an indexed pattern array—a reference grid—can be made to facilitate the characterization of the same region of the grid for experiments involving a series of processing or modifications to a sample). The substrate is then soaked in photoresist developer followed by copper etchant (e.g. ferric chloride, that does not dissolve the graphene), and then in photoresist stripper (i.e., acetone). The copper etchant will remove all exposed copper until it reaches the graphene, resulting in an intact graphene TEM grid. Conventional TEM grids are ˜3.05 mm in diameter, so a small 10 cm×10 cm graphene/copper substrate would result in over one-thousand (1000) high-quality graphene TEM grids in much less time than it takes to produce one (1) grid using current serial methods.

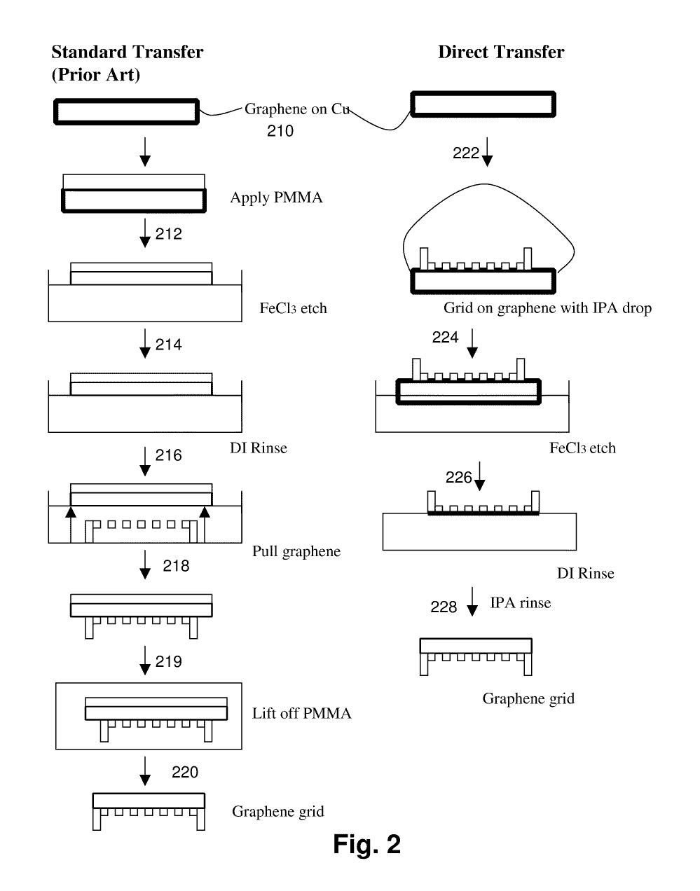

It should be noted that after CVD growth, the entire Cu foil (top and bottom) is covered with graphene (as the carbon-containing gases fill the whole chamber and can touch every part of the foil, as shown at 210 in FIG. 2). The structures shown elsewhere are considered to have graphene only on one side for purposes of simplification. To obtain a substrate-ATF with the ATF (graphene) on one side only, one could remove one side of the graphene coating using something like a reactive ion etching (an oxygen plasma, for instance) that removes the graphene from one side of the Cu foil but doesn't touch the graphene on the other side. However, it was observed in practice that “unprotected” graphene (that is, graphene situated between the Cu foil and the etchant solution, i.e., opposing second side to the ATF) is effectively removed because the etchant can contact a small crack or defect to work its way between the Cu and unprotected graphene. As the Cu directly under this graphene layer is etched, the graphene has nothing to hold onto and is washed away into the etchant solution.

The reason that the “desired” graphene side (i.e., bearing the ATF layer to be suspended) is not washed away in this manner is that either this side of the graphene is already stuck to the target substrate (as in Example 1) or (as in Example 3) it has a protective coating of photoresist on top of it. This protective layer of photoresist is not the side that is patterned, but in addition to the photoresist layer to be patterned.

Thus, in the method of Example 1, where the Cu foil is immersed in etchant, there is a coating of protective photoresist on top of the graphene which will form the atomically thin film suspended across holes in a support mesh and a coating of patterned photoresist on the other side of the Cu foil, the side which is etched. There are other methods to achieve this desired result that don't require a protective coating of photoresist. For instance, there is a way to float the Cu foil on top of the etchant (with the graphene to be suspended side facing up and hence not in contact with the etchant) which avoids the need for a protective photoresist coat on the graphene to be suspended.

The present method is compatible with current methods for preparing TEM microscope grids, and could be adapted to other applications where essentially single layer graphene is needed in a free-standing state, that is having a layer of essentially single layer graphene suspended across an opening which perforates a support. The openings here are of microscopic size, but the opening across which the graphene layer extends can be chosen according to the application involved.

In TEM imaging, the sample under study is placed on a TEM “grid”, which serves the same purpose that a microscope slide does for optical microscopy: it physically supports the sample. For high resolution TEM work, the grid is often composed of amorphous carbon with holes in it. If possible, the sample is suspended across the holes, or cantilevered out over a hole, in order to avoid background signal from the grid material when imaging electrons go through the sample. However, often it is not possible to place the sample over a hole. For example, if one is conducting TEM on an atomic scale, a single atom could not be suspended over a hole. The answer is to first span the hole with a very thin membrane, like ultra-thin plastic food wrap spanning an open bowl. This thin membrane then supports the sample. We use a single-atom-thick graphene layer, the thinnest, strongest continuous material known, to span the holes. In a preferred method, a TEM grid with 1 μm holes is prepared. A portion of the holes then are spanned with a single graphene layer. A conventional TEM does not have the resolution to “see” the individual carbon atoms in the graphene layer, as these carbon atoms are periodically spaced approximately 0.14 nm apart, which is below the resolution limit of most TEMs. Hence such a membrane appears largely “invisible” in a conventional TEM (contributing only a weak uniform background signal). However, small perturbations to the film, as produced, for example, by adsorbed atoms, molecules, or missing carbon atoms in the membrane itself, are visible in the TEM. This sensitivity enhancement (not resolution enhancement) is what allows us to image individual atoms and molecules, including very light atoms such as carbon and even hydrogen. Further details on the use of graphene film in a TEM grid may be found in Meyer, J. C., Girit, C. O., Crommie, M. F. & Zettl, A., “Imaging and dynamics of light atoms and molecules on graphene,” Nature, 454, 319-322 (2008). As described there, a graphene membrane provides the ultimate sample support for electron microscopy. With a thickness of only one atom, it is the thinnest possible continuous material. Owing to its crystalline nature, a graphene support membrane is either completely invisible or, if the graphene lattice is resolved by a very-high-resolution microscope, its contribution to the imaging signal can be easily subtracted. Graphene is also a good electrical conductor and therefore displays minimal charging effects from the electron beam. According to the present method, one may transfer selected graphene sheets to commercially available TEM grids having a carbon mesh or holey carbon. Manufacturers of TEM grids include Quantifoil Micro Tools GmbH, which manufactures and markets its proprietary QUANTIFOIL® support foils for electron microscopy.

### EXAMPLES

Described and exemplified below (Example 1) is a simple method for the direct transfer of layer-area graphene from Cu growth substrates to Au Quantifoil TEM grids with a holey amorphous carbon (a-C) mesh. By avoiding intermediate polymer supports, this direct transfer minimizes contamination and mechanical damage to the graphene sample and results in a strong, clean graphene TEM grid ideal for high-resolution TEM imaging and spectroscopy of a multitude of nanostructures and molecules. In addition, since only minimal mechanical damage is observed in this technique, this method can be applied to fabricate a variety of optical, chemical, and electronic devices that utilize large, suspended (and with both sides easily accessible) uniform graphene sheets.

Referring now to FIG. 2, a comparison between the present inventive method (right) and a standard transfer method (left) is shown. Graphene on Cu 210 is, in the standard method, covered with PMMA at 212. The copper is removed by an FeCl₃ etch at 214. The resultant structure is rinsed with de-ionized water at 216. The graphene PMMA is put onto a TEM grid at 218, PMMA is removed at 219 by lifting PMMA off in acetone, resulting in the structure shown at 220.

By contrast, in accordance with the direct transfer method presented here, the graphene on Cu 210, which may be prepares in a standard method, is shown on the right side of FIG. 2. This layer may be prepared by layer-area graphene growth on a copper foil via low pressure chemical vapor deposition. The graphene on Cu is then contacted with a grid in step 222. It is shown as placed underneath the TEM grid and covered with IPA at 222. The grid is bonded to the graphene-Cu as the IPA evaporates, as discussed below. Next, Cu is removed in a FeCl₃ etch at step 224. The resultant product, with the Cu removed, and comprising the TEM with the graphene attached to the grid, is subjected to a deionized water rinse at step 226 and rinsed with IPA to produce the final product shown at 228.

### Example 1

### Preparation of a Graphene—Holey Carbon Grid Useful as a TEM Support

### Preparation of a Graphene ATF on a Copper Foil Substrate

The direct transfer process begins with layer-area graphene growth on a Cu foil (Alfa Aesar #13382, 25 microns thick) via low-pressure chemical vapor deposition (See FIGS. 1 and 2).

Assembling the ATF-Substrate on a Carbon Grid Support so that the Graphene and Carbon are in Contact A hole-bearing carbon support over a target TEM grid (SPI Au Quantifoil with 1.2 um holey amorphous-C, (“a-C) film) is placed on top of the graphene on Cu, such that the a-C film faces down towards the graphene. Other forms of mesh on foil TEM supports may be obtained or used. These are sold e.g., by Ted Pella, Inc. Redding, Calif. See, FIG. 1A.

### Adhering the ATF Graphene to the Carbon Grid

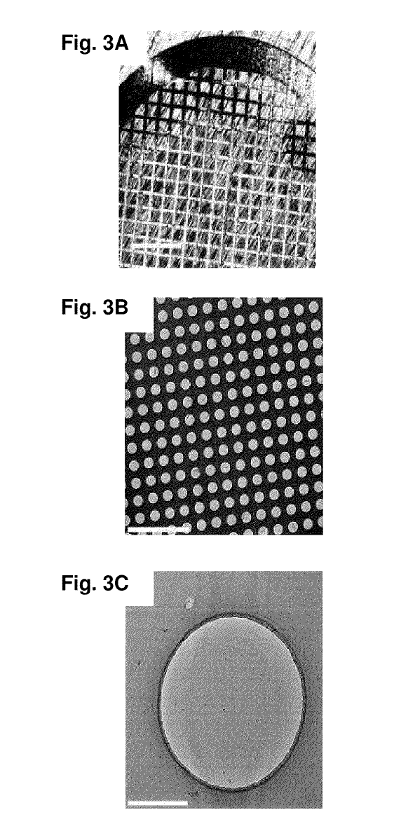

A drop of isopropanol (IPA) is gently placed on top of the grid, wetting both the grid's a-C film and the underlying graphene film. As the IPA evaporates, surface tension draws the graphene and a-C together into intimate contact. The completeness of the adhesion between the graphene and a-C can be confirmed by optical microscopy, as optical interference effects give a noticeable contrast difference between adhered and non-adhered regions (FIG. 2, 222 and FIG. 3).

FIG. 3A shows a grid near the end of this evaporative process, when all but the top portion of the grid has been sucked onto the graphene on Cu. If certain regions remain unstuck, more IPA may be dropped on the sample and evaporated until all regions of the films are adequately bonded. The sample is then baked on a hot plate at 120 degrees Celsius for 10 to 20 minutes to evaporate any remaining IPA and strengthen the graphene/a-C bond.

Removal of the Substrate Metal Foil from the Assembly

Next, the sample is floated on a solution of aqueous FeCl₃ (0.1 g/mL) in order to remove the underlying Cu foil (FIG. 2, 224). During this process, the sample should be oriented such that the TEM grid rests on top of the Cu film. The Cu foil takes approximately 2 hours to completely etch and expose the graphene. The sample, now referred to as a graphene TEM grid, is then floated on deionized water to wash off remaining Cu etchant (FIG. 2, 226). After a brief bath in IPA to encourage effective drying and remove organics, the grid is ready for use. In short, besides being a much cleaner process involving fewer potential contaminants (PMMA, acetone), the direct transfer process proposed here produces a very robust graphene TEM grid. By anchoring the grid's a-C film to the graphene in the first wet step (FIG. 1A), the direct transfer process avoids mechanical damage suffered during multiple wet transfers of the graphene/polymer film, a difficulty shared by all polymer-supported transfer methods.

### Example 2

### Characterization of Graphene TEM Grids

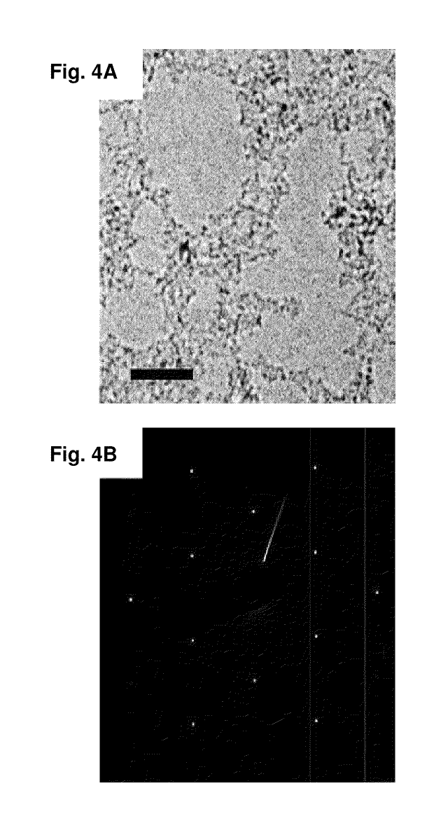

Characterization of direct transfer graphene TEM grids is performed on a JEOL 2010 TEM operated at 100 kV. FIG. 3 shows the graphene grid prepared in Example 1 at different magnifications. Macroscopic grid-wide graphene coverage is apparent in FIG. 3A, an optical micrograph captured near the end of the evaporative adhesion step. Darker regions in this image show where graphene has bonded to the a-C support. FIG. 3B, a subset of a grid frame captured by TEM, reveals large unperturbed graphene sheets with occasional folds and cracks. FIG. 3C shows a higher magnification image of a single graphene domain covering an a-C hole. FIG. 4A shows a typical view of the suspended graphene, with large (tens of nanometers) atomically clean regions separated by scattered amorphous and/or organic materials covering the highly reactive graphene surface, rivaling the cleanliness seen earlier with exfoliated graphene flakes transferred to TEM grids and described in Meyer et al., Nature, 454, 319 (2008), referenced above. We detected no evidence of polycrystalline Cu residue on the surface, suggesting a complete and clean etch. Selected area diffraction (SAD) of the region in FIG. 4A is shown in FIG. 4B, revealing the distinctive hexagonal structure of graphene. The invariant intensity of the diffraction pattern during tilting gives unambiguous evidence that the membrane is indeed a single layer.

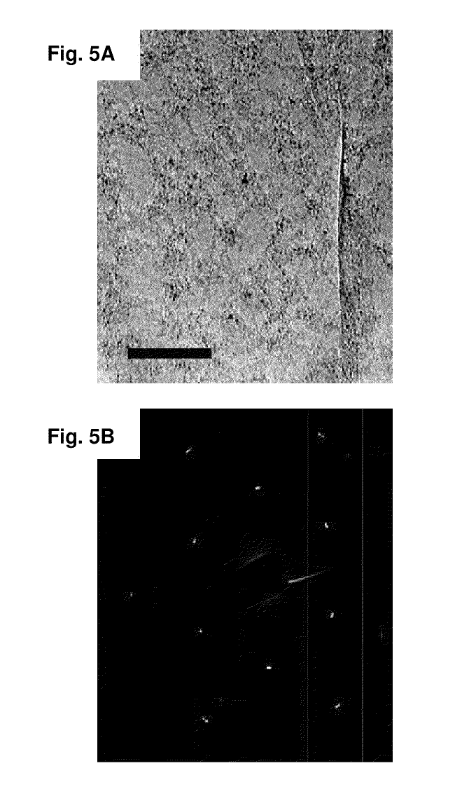

FIG. 5A reveals a fold or grain boundary. Folds are commonly seen in metal-based layer-area graphene growth, possibly forming to relieve stress during the cooling of the graphene and metal from the high synthesis temperature down to room temperature. The corresponding SAD in FIG. 5B again shows the characteristic hexagonal structure of this region. The large and small angle separation of the diffraction spots results from the sheet misalignment caused by the fold or grain boundary.

In summary, the above examples illustrate a novel technique for the transfer of layer-area graphene to holey a-C TEM grids. This technique yields complete grid coverage, a strong bond between the grid support film and the graphene, and a highly uncontaminated graphene surface, making the graphene TEM grid well suited for high resolution TEM. The resulting grid is substantially easier to work with than previous grids made with exfoliated flakes. Millimeter-scale graphene coverage avoids the need for precise aiming when preparing graphene-supported samples. Further, grid preparation is reliable and fast, limited in speed only by the etching rate. With a more concentrated Cu etchant than that used in this letter, a batch of several graphene grids can easily be produced in under an hour.

Beyond being the ideal support for high resolution TEM, the graphene TEM grid (and related devices made with variations of our direct transfer technique) may enable a multitude of new studies and technologies in such areas as hydrogen storage, gas sensing, electrochemistry, catalysis, and other advanced electrical and optical devices.

### Example 3

### Photolithographic Patterning to Selectively Etch Cu Growth Substrates: an Alternate Route to Suspended Graphene Architectures

As shown in FIG. 6A, foil 102 is layered with graphene 104 as previously described. A layer of photoresist 602 (FIG. 6B) is applied to the copper foil layer. FIG. 6C shows a photomask containing the structure of the entire TEM grid (scaffolding, outer support ring, etc.) being placed over the substrate. As is known in the art of photolithography, UV light is shined on the structure through the mask 608. (The photomasks can be designed to have arbitrary geometric layout; for instance, a mask containing an indexed pattern array—a reference grid—can be made to facilitate the characterization of the same region of the grid for experiments involving a series of processing or modifications to a sample). The exposed photoresist is then removed (FIG. 6D) when the substrate is soaked in photoresist developer; after copper etching, the remaining photoresist is removed with photoresist stripper (i.e., acetone). The copper etchant will remove all exposed copper until it reaches the graphene, resulting in an intact graphene TEM grid 610, as shown in FIG. 6E. Conventional TEM grids are ˜3.05 mm in diameter, so a small 10 cm by 10 cm graphene/copper substrate would result in over one-thousand (1000) high-quality graphene TEM grids in much less time than it takes to produce one (1) grid using current serial methods. Although the etching process is anisotropic, the features are designed to allow etching to proceed completely through the substrate to reach (and stop at) the ATF while maintaining the desired pattern, which would be for example, a grid or mesh.

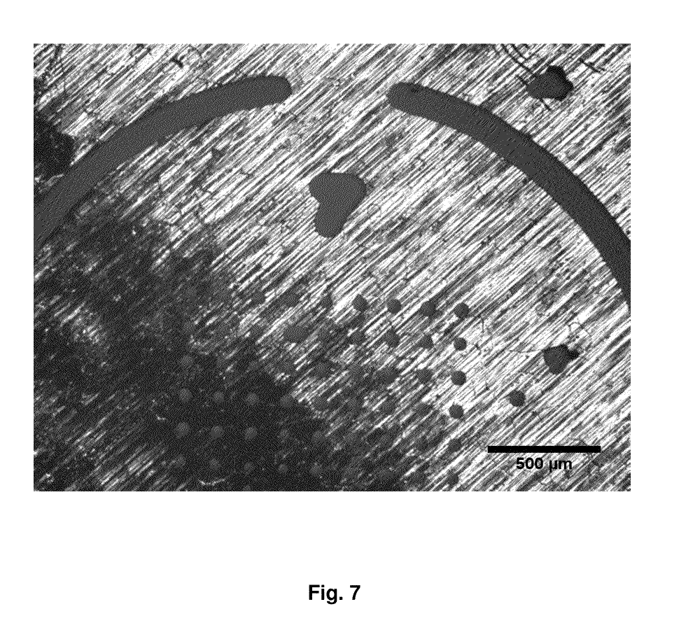

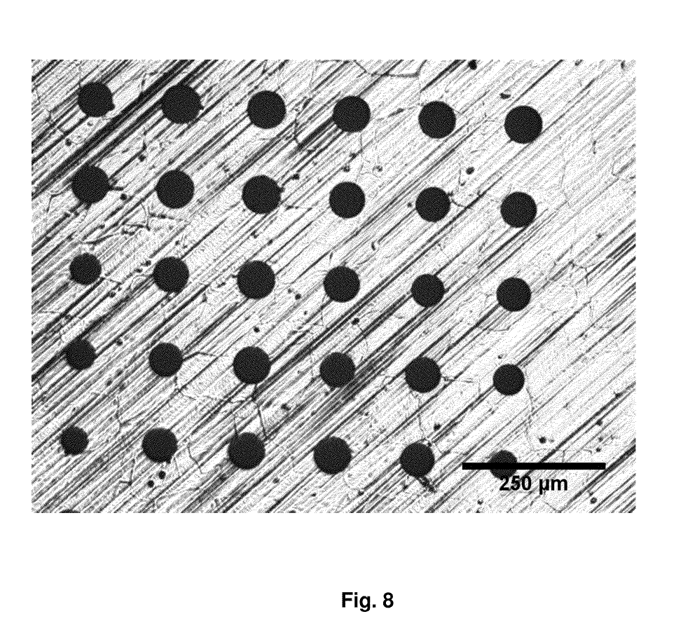

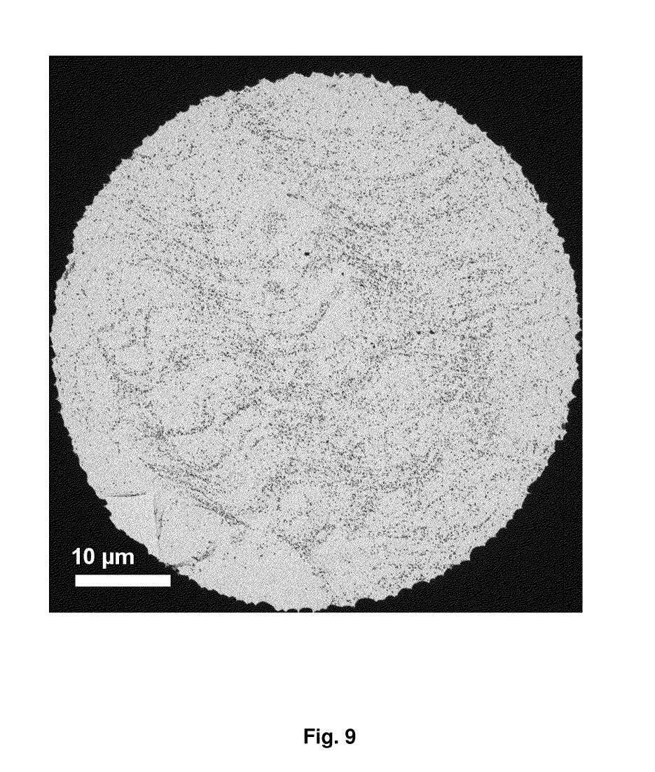

The fabrication of a graphene-suspended copper support mesh, as shown in FIG. 7, FIG. 8 and FIG. 9 was carried out. The steps may be summarized as follows:

Throughout the process, light exposure should be minimized to avoid unwanted exposure of photoresist and subsequent uncontrolled etch marks across film.
1) Spin coat photoresist on top (graphene side up) of Cu foil. Cure resist on hotplate. 1-line photoresist, commercially available, and described further e.g., in U.S. Pat. No. 6,613,495, was used in a UV ozone chamber.
2) (optional) Remove graphene on bottom side of Cu foil with reactive ion etch. It is observed that this step is not necessary, as the etchant can work its way beneath the bottom layer of graphene and etch the Cu, destroying the bottom layer of graphene in the process.
3) Spin coat photoresist on bottom (etch side) of Cu foil. Cure resist on hotplate.
4) With the graphene side of sample now facing down, align photomask (with TEM grid patterns) on top of photoresist/Cu/graphene sandwich. Expose resist in UV Ozone or other UV light source.
5) Post-exposure bake of resist.
6) Develop in TMAH (Tetramethyl ammonium hydroxide) or other resist developer and rinse in deionized water. Dry sample.
7) Submerse Cu film in FeCl₃ (etch side up, graphene side down) to etch patterned regions of Cu.
8) Once Cu has etched through, remove foil from etchant and rinse in deionized water.
9) Remove remaining photoresist in acetone and subsequently rinse the sample in isopropanol.
10) The end result will be a batch of TEM grids (as many as are defined by the photomask). Remove individual grids by cutting through the small Cu tabs on the top and bottom of each grid.

FIG. 9 is a TEM image of one of the suspended graphene regions seen in FIG. 7 and FIG. 8 and made according to the process of this example. It demonstrates that graphene survives the procedure. The suspended graphene in the optical micrographs in FIGS. 7 and 8 is not seen.

### CONCLUSION

The above specific description is meant to exemplify and illustrate the invention and should not be seen as limiting the scope of the invention, which is defined by the literal and equivalent scope of the appended claims. Any patents or publications mentioned in this specification are intended to convey details of methods and materials useful in carrying out certain aspects of the invention which may not be explicitly set out but which would be understood by workers in the field. Such patents or publications are hereby incorporated by reference to the same extent as if each was specifically and individually incorporated by reference and contained herein, as needed for the purpose of describing and enabling the method or material referred to.

What is claimed is:

1. A method of preparing a structure comprising an atomically thin film (“ATF”) suspended across at least one hole in a support mesh, comprising the steps of:
(a) obtaining an ATF layer on a surface of a solid substrate;
(b) attaching the ATF layer on the solid substrate from step (a) to a support mesh having at least one hole therein;
(c) removing the solid substrate, leaving the ATF layer from the substrate attached to the support mesh and suspended across at least on hole in the support mesh; and
(d) removing any contaminants remaining on the ATF layer, to obtain said structure.

2. The method of claim 1 where the atomically thin film (“ATF”) layer is essentially single layer graphene.

3. The method of claim 1 where the atomically thin film (“ATF”) layer is selected from the group consisting of graphene, BN, BxCyNz, and thin film dichalcogenides.

4. The method of claim 1 where the solid substrate is a metallic material which contains copper, nickel, silver, ruthenium, palladium, platinum, or other metals with low carbon solubility.

5. The method of claim 4 where the substrate contains copper.

6. The method of claim 5 where the substrate is elemental copper.

7. The method of claim 1 where the solid substrate contains silicon.

8. The method of claim 1 where the support mesh comprises a carbonaceous layer, such as holey carbon on an underlying grid.

9. The method of claim 8 where the holey carbon is amorphous carbon.

10. The method of claim 8 where the holey carbon has a nominal sieve opening size of between 100 nm and 100 μm.

11. The method of claim 8 where the removing of the solid substrate step comprises the step of etching.

12. The method of claim 8 where the step of attaching the atomically thin film layer to the carbonaceous hole-containing layer comprises the step of adding a solvent to a junction between said atomically thin film layer and carbonaceous hole-containing layer.

13. The method of claim 12 where the solvent is a lower alkyl alcohol.

14. The method of claim 13 where the lower alkyl alcohol is isopropyl alcohol.

15. The method of claim 1 where the step of obtaining an ATF layer comprises the step of applying the ATF layer by chemical vapor deposition on a copper foil.

16. A structure for use in preparing a support structure for a suspended single layer atomically thin film, comprising:
(a) an essentially single layer atomically thin film layer on a substrate; and
(b) a hole-containing layer on a support mesh attached to said atomically thin film layer by bonding of the atomically thin film layer to the hole-containing layer.

17. The structure of claim 16 where the support mesh is gold.

18. The structure of claim 16 where the substrate contains an etchable metal.

19. The structure of claim 18 where the etchable metal is copper.

20. The structure of claim 16 where the hole-containing layer is holey amorphous carbon.

21. The structure of claim 20 where the holey amorphous carbon has a nominal sieve opening of between 100 nm and 100 μm.

22. A method of preparing a structure comprising an atomically thin film (“ATF”) suspended across at least one hole in a support mesh, comprising the steps of:
(a) obtaining an ATF layer on a surface of a solid substrate, said solid substrate having a first ATF layered side and an opposing second side;
(b) preparing an etching pattern on the opposing second side of the substrate, the etching pattern comprising defined portions of the substrate to be etched; then
(c) etching the defined portions to remove substrate, leaving the ATF layer suspended across at least one hole formed by etched portions and leaving unetched portions forming a support mesh; and then
(d) removing contaminants to obtain said structure having an atomically thin film layer suspended across at least one hole in a support mesh.

23. The method of claim 22 where the step of preparing an etching pattern comprises steps of coating a resist on the opposing second side of the substrate and exposing the resist to an agent that passes through a mask which forms said pattern, and then removing the resist to form said defined portions to be removed.

24. The method of claim 22 where the resist is a positive photoresist.

25. The method of claim 22 further comprising steps of applying a resist to the ATF layer and exposing the photoresist to radiation, and removing exposed portions of the photoresist prior to said etching.

26. The method of claim 25 where the ATF layer is essentially single layer graphene.

27. The method of claim 25 where the atomically thin film layer is selected from the group consisting of graphene, BN, BxCyNz, and thin film dichalcogenides.

28. The method of claim 25 where the solid substrate is a metallic material which contains copper, nickel, silver, ruthenium, palladium, platinum, or other metals with low carbon solubility.

29. The method of claim 28 where the substrate contains copper.

30. The method of claim 29 where the substrate is elemental copper.

31. The method of claim 25 where the solid substrate contains silicon.

32. The method of claim 22 where the support mesh comprises a carbonaceous layer, such as holey carbon.

33. The method of claim 32 where the holey carbon is amorphous carbon.

34. The method of claim 33 where the holey carbon has a nominal sieve opening size of between 100 nm and 100 μm.

35. The method of claim 22 where multiple structures are prepared simultaneously from the same solid substrate.

36. The method of claim 22 wherein the step of obtaining an ATF layer on a surface of a solid substrate comprises the step of chemical vapor deposition.
